(19) United States
(12) Patent Application Publication
(10) Pub. No.: US 2005/0115339 A1
(43) Pub. Date: Jun. 2, 2005

(54) Starter

(76) Inventors: Shuichi Aoki, Maebashi-shi (JP); Sadayoshi Kajino, Nagoya-shi (JP); Youichi Hasegawa, Kasugai-shi (JP)

Correspondence Address: McGLEW AND TUTTLE, P. C.;Counselors at Law, SCARBOROUGH STATION, SCARBOROUGH, NY, 10510-0827, US

(21) Appl. No.: 10/975,092

(22) Filed: Oct. 27, 2004

(30) Foreign Application Priority Data
Oct. 30, 2003 (JP) 2003/370703

(51) Int. Cl. F02N 11/00

(52) U.S. Cl. 74/7 C; 74/7 E

(57) ABSTRACT

There is provided a starter in which a brake plate can be assembled or replaced easily. In the starter including a motor which is started by the energization of an armature caused by an ON operation of an electromagnetic switch; a pinion shift lever driven corresponding to the ON operation of the electromagnetic switch; a pinion which is engaged with a ring gear of an engine corresponding to the drive of the pinion shift lever while being rotated corresponding to the start of the motor; and a clutch which is spline connected so that one of the motor output shaft side and the pinion shaft side has splines two times the number of splines of the other and a stopper mechanism utilizing the two-times splines with respect to the axial movement is provided, locking means for detachably fixing a brake plate is provided on a wall surface on the pinion side of a center bracket.

### BACKGROUND OF THE INVENTION

1. Field of the Invention

The present invention relates to a starter which is constructed so that the inertial rotation of a motor is rapidly terminated after the energization of the motor has been shut off after the start of an engine, and also relates to an improvement in a brake mechanism thereof.

2. Description of the Related Art

FIG. 1 is a sectional view of an essential portion of one embodiment of a starter in accordance with the present invention. By using FIG. 1, a relation between an electromagnetic switch, motor, pinion shift lever, pinion, and clutch in the starter is explained first.

In the figure, reference numeral 1 denotes a starter, 2 denotes an electromagnetic switch, 3 denotes a pinion, 4 denotes a clutch outer, 5 denotes a pinion shift lever, and 6 denotes a motor.

In FIG. 1, the electromagnetic switch 2 includes a driving coil 22 wound on a hollow cylindrical coil bobbin 21, a fixed iron core 23 fixed in the hollow space of the coil bobbin 21, a movable iron core 24 supported movably in the hollow space of the coil bobbin 21, a driving shaft 25 which is fixed to the movable iron core 24 and has an engagement portion 25a at one end and a movable contact portion 26 on the other hand, terminals 28, 28, and fixed contacts 27, 27 connected to the terminals 28.

In FIG. 1, on the upside of the centerline of the electromagnetic switch 2, a state is shown in which the driving coil 22 is in a de-energized state so that the driving shaft 25 is located on the left-hand side in the figure, and the movable contact portion 26 is not in contact with the fixed contact 27. On the downside of the centerline thereof, a state is shown in which the driving coil 22 is in an energized state so that the driving shaft 25 is located on the right-hand side in the figure, and the movable contact portion 26 is in contact with the fixed contact 27.

The electromagnetic switch 2 is configured as described below. When an ignition switch (not shown) of a vehicle is turned on, the driving coil 22 is energized by a battery (not shown), and thus the driving shaft 25 is moved to the right-hand side in the figure. Thereby, a forked head portion of the pinion shift lever 5 engaged with the engagement portion 25a is turned in the clockwise direction with a lever pin 73 being a support point as indicated by the broken line in the figure. A roller 56 provided in a forked leg portion of the pinion shift lever 5 moves a shifter portion 42 connectingly provided on the clutch outer 4 in the left direction in the figure, and the pinion 3 fixed to a clutch inner 4a via a clutch roller 4b is pushed out to the left-hand side in the figure while being rotated slowly by the action of a spline cylindrical portion 41 and helical splines 44. When the pinion 3 meshes with a ring gear, not shown, on the engine side, the motor 6 is started by the contact of the movable contact portion 26 of the electromagnetic switch 2 with the fixed contacts 27, 27, by which an engine is started.

In FIG. 1, on the upside of the centerline of the pinion 3, clutch outer 4, and motor 6, a state is shown in which the pinion 3 is not projected, and on the downside of the centerline thereof, a state is shown in which the pinion 3 is projected.

After the not illustrated engine has been started, the driving coil 22 of the electromagnetic switch 2 is de-energized, and thereby the movable iron core 24 is returned to the left-hand side in the figure. The movable contact portion 26 is separated from the fixed contacts 27, 27, so that the power to the motor 6 is shut off, and also the pinion shift lever 5 is returned to the original position as indicated by the solid line in the figure.

Reference numeral 17 denotes a rear bracket for the motor 6, 18 denotes a center bracket for the motor 6, and 19 denotes a brake plate. Also, a collar portion 43 of the clutch outer 4 has a construction such that when the pinion 3 returns to the not-projected state, the end surface of the collar portion 43 comes into contact with the brake plate 19 that partially overlaps with an output shaft of the motor 6 in a ring form to terminate the inertial rotation of the motor 6 via the brake plate 19. This construction in which when the pinion 3 returns to the not-projected state, the end surface of the collar portion 43 comes into contact with the brake plate 19 to terminate the inertial rotation of the motor 6 is a structural portion of the present invention. This structural portion will be explained in more detail later with reference to FIGS. 2 through 5.

In the above explanation, the relation between the electromagnetic switch 2, pinion 3, clutch outer 4, pinion shift lever 5, and motor 6 in the starter 1 has been described. Hereunder, a construction of a stopper mechanism against the axial movement of the pinion 3 used in the conventional starter, and a construction of a stopper mechanism of a clutch using a helical spline connection will be explained.

The applicants of the present invention have proposed a starter described in Japanese Patent Laid-Open No. 2003-214304. The starter described in said Japanese Patent Laid-Open No. 2003-214304 is explained with reference to FIGS. 6 and 7. FIG. 6 is a partially sectional view of a portion near a clutch and a reducer of a conventional starter, and FIG. 7 is a sectional view taken along the line A-A of FIG. 6.

In FIGS. 6 and 7, an armature shaft 153 of a motor 152 constituting the starter is coaxially connected to an output shaft 155 via a reducer 154, and the output shaft 155 is rotatably supported on a center bracket 157 via a bearing 156.

The reducer 154 is a planetary gear speed reducing mechanism made up of a sun gear 158 provided on the armature shaft 153, a ring-shaped internal gear 159 which is arranged at the outer periphery in the radial direction of the sun gear 158 and the rotation of which is regulated by the center bracket 157, a plurality of planetary gears 160 meshing with the sun gear 158 and the internal gear 159, and the like. The planetary gear 160 is rotatably supported on a carrier pin 162 fixed to a collar portion 150 provided on the motor side of the output shaft 155 via a bearing 161.

A clutch 163 arranged on the output shaft 155 is constructed so as to be helical spline connected and capable of moving in the axial direction. The clutch 163 is moved in the left direction in FIG. 6 by the roller located in a cylindrical portion 165 via a lever 164 which tilts in response to an ON operation of the electromagnetic switch 2, and is moved in the right direction in FIG. 6 via the lever 164 which returns to the original position in response to an OFF operation of the electromagnetic switch 2. At this time, a collar portion 166 connectingly provided on the clutch 163 presses a ring-shaped brake member 167 shown in FIG. 8. The collar portion 166 is constructed so as to be also used as a stopper for stopping the movement in the right direction of the shaft of the clutch 163 and also to rapidly terminate the inertial rotation of the motor 152 after the engine has been started.

The brake member 167 is arranged in a bearing portion 168 provided on the center bracket 157, and fixed to the bearing portion 168 by staking as shown in FIG. 7. Also, as shown in FIG. 8, the brake member 167 has a protrusion 169, and the rotation of the brake member 167 is regulated by fitting this protrusion 169 in a concave portion 170 provided in the bearing portion 168.

Japanese Patent Publication No. 58-23501 has disclosed a starter which incorporates a stopper mechanism in a clutch using a helical spline connection.

FIG. 9 is a partially sectioned front view of an essential portion of a conventional starter having a clutch incorporating a pinion movement stopping mechanism, FIG. 10 is a perspective view of an output shaft used in FIG. 9, and FIG. 11 is a partially sectional view of a clutch outer. FIG. 12 is a sectional view taken along the line B-B of FIG. 10, and FIG. 13 is a sectional view taken along the line C-C of FIG. 10.

In FIGS. 9 through 13, a clutch 175 of a starter 171 includes a clutch inner 182 slidably provided between an output shaft 174 integrally forming a pinion 179 at the tip end thereof and a housing case 176 via bearings 180 and 181, and a clutch outer 184 connected to the outer periphery at one end on the anti-pinion side of the clutch inner 182 via a plurality of engagement elements 183. On the inner peripheral surface at one end of the clutch outer 184, as shown in FIG. 11, five helical splines 185 are formed at equiangular positions at intervals of 72 degrees, and the output shaft opposed to the clutch outer 184 is formed with ten (a multiple of integer) second helical splines (helical spline grooves) 186 arranged at equiangular positions. As shown in FIGS. 11 to 13, the arrangement angle between the helical splines 185 on the inner peripheral surface of the clutch outer 184 is θ₁, while the angle between first helical splines (helical spline grooves) 188 receiving the helical splines 185 is θ₂. On the other hand, the angles on the side of the second helical splines 186 are θ₃ and θ₄, and the relationship of these angles is θ₁=θ₂=θ₃=θ₄. Therefore, the number of second helical splines 186 shown in FIG. 12 is two times that of first helical splines 188.

On the other hand, in a portion 187 serving as the pinion movement stopping mechanism, the first helical splines 188 are formed at intervals equal to the intervals of the helical splines 185 on the clutch outer 184, and portions other than the first helical splines 188 are used as contact portions of the pinion movement stopping mechanism. A groove 189 is formed between the first helical splines 188 and the second helical splines 186 to facilitate machining of the second helical splines 186 provided between the first helical splines 188. On the other hand, an end portion of the second helical splines 186 forms a stepped portion 190. This stepped portion 190 provides a clearance by which at least the helical splines 185 of the clutch outer 184 can be rotated without making contact. Reference numeral 172 denotes a motor, 177 denotes an electromagnetic switch, and 178 denotes a lever.

In the configuration of such a clutch 175, the clutch 175 is assembled as described below. The clutch 175 is inserted from the pinion 179 side with the output shaft 174 being the center, the helical splines 185 of the clutch outer 184 are first engaged with the first helical splines 188, and, by advancing further, are engaged with splines of the same spiral shape as the first helical splines 188, of the second helical splines 186. By advancing further, the helical splines 185 of the clutch outer 184 are disengaged and caused to correspond to the stepped portion 190. At this time, by rotating the clutch outer 184 to the right or left by one spline, the helical splines 185 of the clutch outer 184 are caused to face the intermediate splines, and are engaged with them by being rotated to the left. The helical splines 185 of the clutch outer 184 are returned while being rotated until being locked by the portion 187 of the pinion movement stopping mechanism. Thereafter, a clip 192 is fitted near the pinion 179, thereby completing the assembly.

By merely providing the first helical splines 188 and the second helical splines 186, which have a different number of splines, separately on the output shaft 174, the pinion movement stopping mechanism can be provided. The starter 171 has a construction in which the stopper in the movement direction of the output shaft 174 is formed by the pinion movement stopping mechanism incorporated in the clutch 175 and the clip 192 provided near the pinion 179.

Besides, as a construction of a stopper mechanism for stopping the axial movement of pinion used in the conventional starter, in Japanese Utility Model Laid-Open No. 61-12976, a stopper member is fixed to a pinion shaft by a retaining ring, and the movement direction of the pinion shaft is regulated by the stopper member.

In the case where staking is used to install the brake member 167 in the conventional starter shown in FIGS. 6 to 8, the brake member 167 is first installed to the bearing portion 168 of the output shaft 155 by using staking portions 200. The reason for this is that if it is assumed that a stopper mechanism using two types of helical splines connections of five and ten in number is adopted as explained with reference to FIGS. 8 through 13, a clearance is not provided if the brake member 167 is first installed to the bearing portion 168 of the output shaft 155, and when a need for replacing the brake member 167 arises, the brake member 167 cannot be removed or installed. In other words, in the conventional starter of a type in which the stopper mechanism using the two helical spline connections shown in FIGS. 6 to 8 is provided and the braking member 167 is installed by staking, at the time of assembling, the brake member 167 is first installed to the center bracket 157. Therefore, a space for turning the clutch 163 in its circumferential direction cannot be secured, and helical spline connection cannot be made by shifting one spline. Also, when it is desirable to replace the brake member 167, the center bracket 157 must also be replaced together with the brake member 167.

### SUMMARY OF THE INVENTION

It is an object of the present invention to provide a stator to rapidly terminate the inertial rotation of motor occurring when the engine is started.

It is anther object of the present invention to provide a stator of which the brake plate can be assembled later, so that the assembling workability is improved, and also of which the brake plate can be replaced, which improves the overhaul ability and thus offers an economical advantage.

It is further another object of the present invention to provide a brake plate suitable for terminating the inertial rotation of motor rapidly.

In a preferred embodiment disclosed by the present invention, the present invention provides a starter including an electromagnetic switch; a motor which has an armature pivotally supported on a rear bracket and a center bracket and is started by the energization of the armature caused by an ON operation of the electromagnetic switch; a pinion shift lever driven corresponding to the ON operation of the electromagnetic switch; a pinion which is engaged with a ring gear of an engine corresponding to the drive of the pinion shift lever while being rotated corresponding to the start of the motor; a clutch which is spline connected so that one of the motor output shaft side and the pinion shaft side has splines two times the number of splines of the other and a stopper mechanism utilizing the two-times splines with respect to the axial movement is provided; and a reducer provided between the motor output shaft side and the pinion shaft side, wherein locking means for detachably fixing a brake plate is provided on a wall surface on the pinion side of the center bracket pivotally supporting an output shaft of the reducer.

A concave portion (hereunder referred sometimes to as a substantially circular concave portion), which has a substantially circular shape as viewed from the front and has a vertical wall around it, is provided in a bearing surface on the pinion side of the center bracket, and a clip groove is provided in the inner peripheral surface of the substantially circular concave portion. Therefore, even for the clutch having the stopper mechanism utilizing different helical spline connections in which the number of splines is two times, the brake plate can be assembled later, and also can be replaced. Also, parts setting can be performed by alternative parts, so that the overhaul ability is improved.

Since the brake plate is circular in shape and is provided with an expanded portion, at the time of operation for terminating the inertial rotation of motor, the rotation of the brake plate is inhibited, so that motor inertial rotation terminating performance is high.

### BRIEF DESCRIPTION OF THE DRAWINGS

FIG. 1 is a sectional view of an essential portion of one embodiment of a starter in accordance with the present invention;

FIG. 2 is an assembly view of a center bracket;

FIG. 3 is an explanatory view of a shape of a brake plate;

FIG. 4 is an explanatory view of a shape of a clip;

FIG. 5 is an explanatory view of an assembly of a brake plate in accordance with the present invention;

FIG. 6 is a partially sectional view of a portion near a clutch and a reducer of a conventional starter;

FIG. 7 is a sectional view taken along the line A-A of FIG. 6;

FIG. 8 is an explanatory view of a shape of a brake member;

FIG. 9 is a partially sectioned front view of an essential portion of a conventional starter having a clutch incorporating a pinion movement stopping mechanism;

FIG. 10 is a perspective view of an output shaft used in FIG. 9;

FIG. 11 is a partially sectional view of a clutch outer;

FIG. 12 is a sectional view taken along the line B-B of FIG. 10; and

FIG. 13 is a sectional view taken along the line C-C of FIG. 10.

### DETAILED DESCRIPTION OF THE PREFERRED EMBODIMENTS

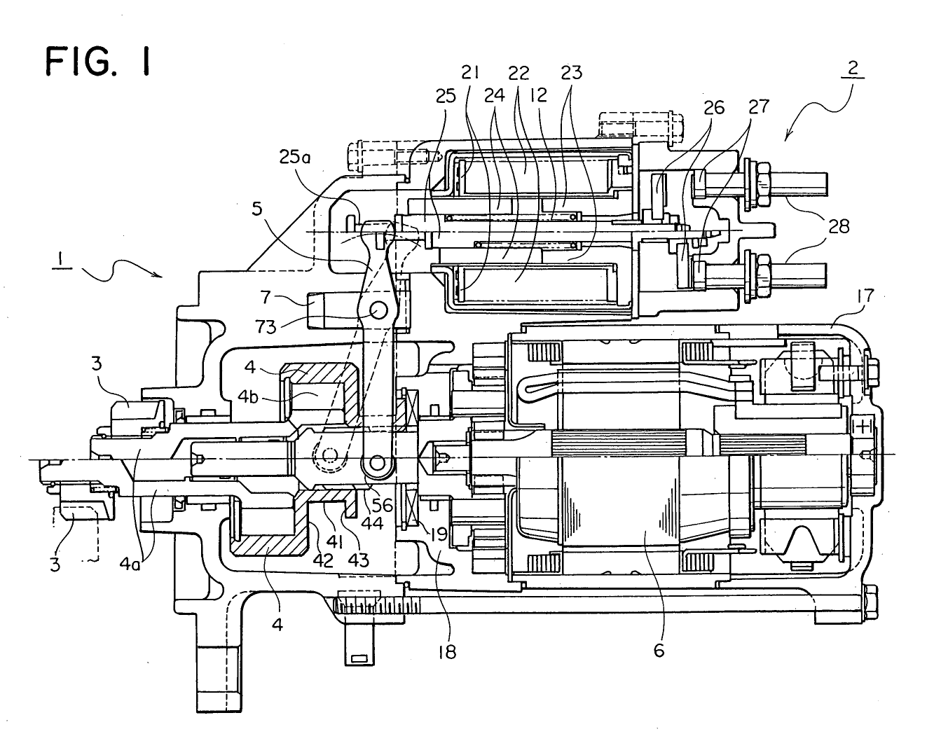

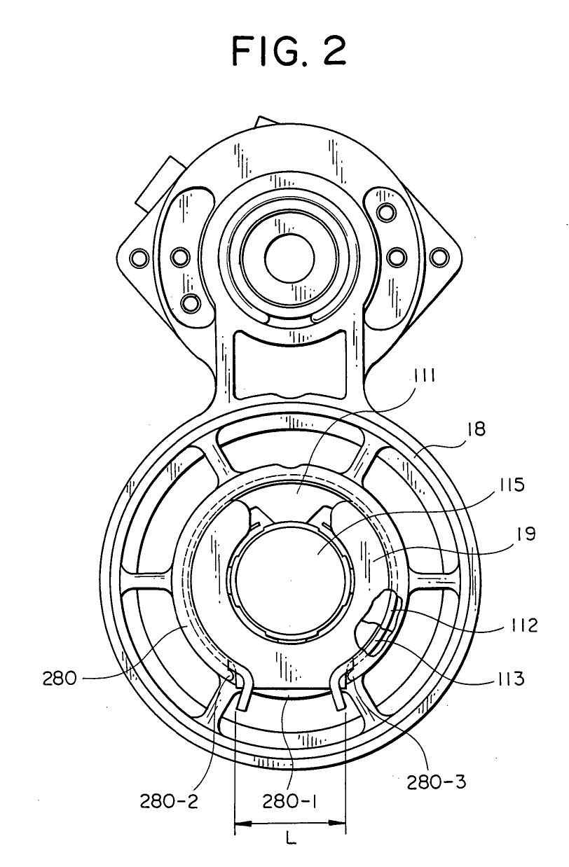

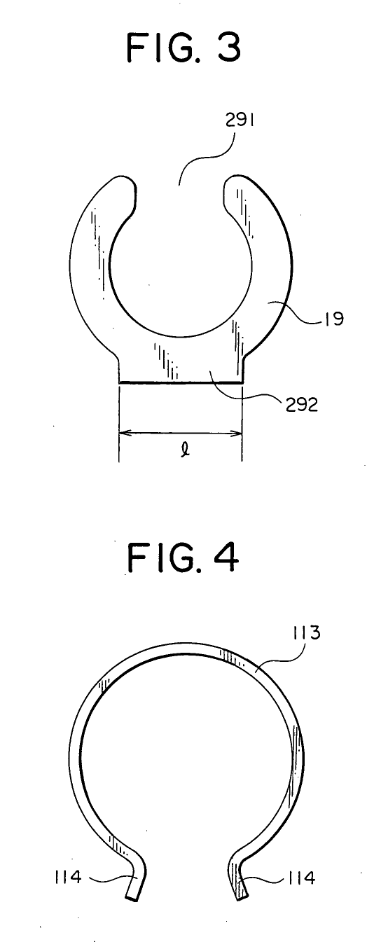

FIG. 1 is a sectional view of an essential portion of one embodiment of a starter in accordance with the present invention. Elements denoted by reference numerals 1 to 6 in FIG. 1 may be regarded as the same as the elements used in the conventional starter. The elements are the same as those described in background of the invention before, and the operations thereof have also been described in background of the invention before, so that repeated explanation is omitted. However, some explanation is added by using FIG. 2, which is an assembly view of a center bracket, FIG. 3, which is an explanatory view of a shape of a brake plate, and FIG. 4, which is an explanatory view of a shape of a clip.

In FIGS. 1 to 3, on the wall surface on the pinion side of the center bracket 18 on which the motor 6 is disposed, there are provided a substantially circular concave portion 111 for housing a substantially circular brake plate 19 shown in FIG. 3 and a clip groove 112 for fixing the brake plate 19 on the inner peripheral surface of the concave portion 111. The construction is such that the brake plate 19 is placed in the substantially circular concave portion 111, and is fixed to the center bracket 18 by fitting a clip 113 in the clip groove 112.

The brake plate 19 is formed of a resin material such as a Bakelite plate or a cloth-inserted Bakelite plate or a metallic material such as an iron plate. Preferably, a resin plate impregnated with oils should be used. In this case, even if the clutch outer 4 is pressed while being rotated, the wear of the brake plate 19 can be reduced, and frictional noise generated when the brake plate 19 comes into contact with the rotating clutch outer 4 can be reduced.

Also, in a part of the brake plate 19, an opening 291 is provided so that the brake plate 19 can be inserted from the radial direction (the side) of an output shaft 115 as described later.

As the clip 113, an elastic member is used. As shown in FIG. 4, in both end portions of the clip 113, which is formed in a substantially circular shape having an opening portion, an attachment/detachment end portion 114 is formed to facilitate attachment and detachment of the clip 113 into and from the clip groove 112. Although the attachment/detachment end portion 114 shown in FIG. 4 is formed in a bent shape, it may be formed in a circular shape having a small radius.

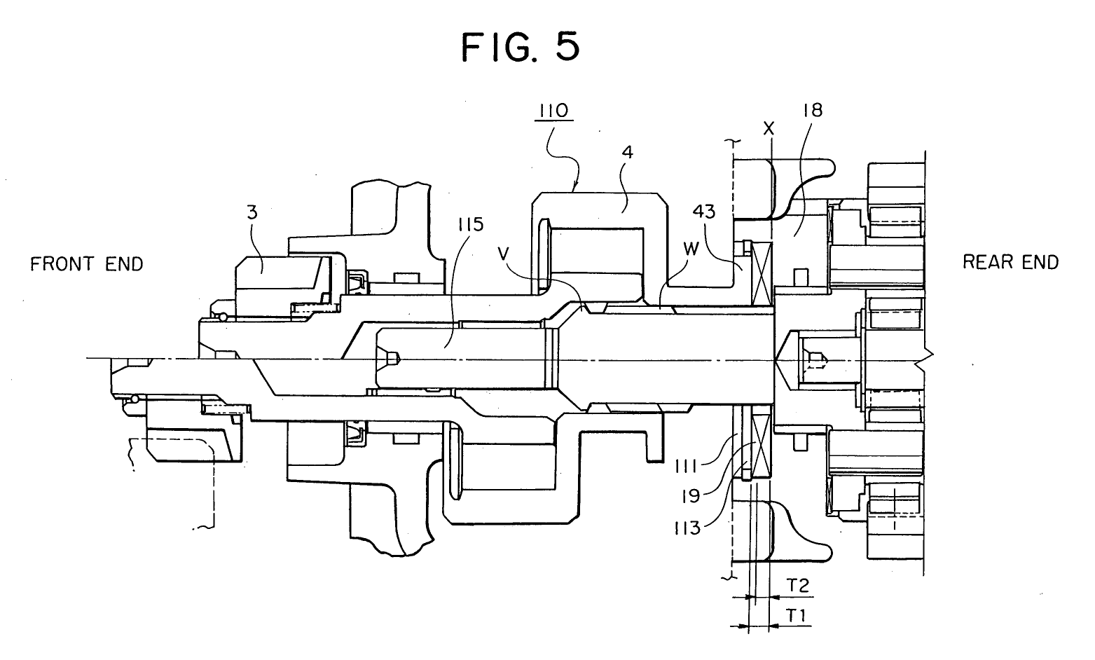

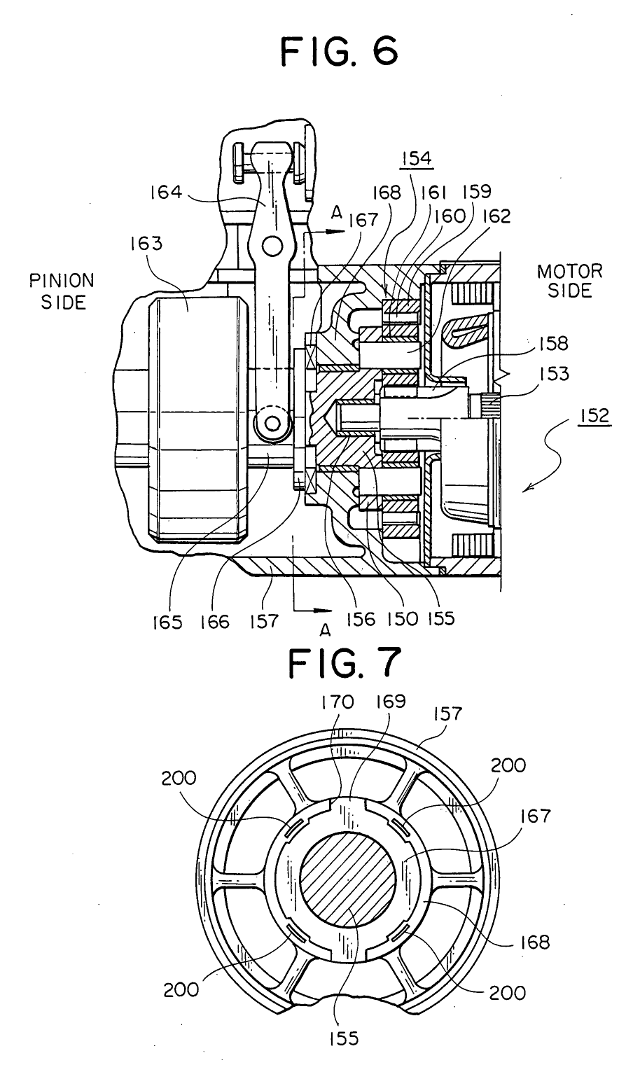

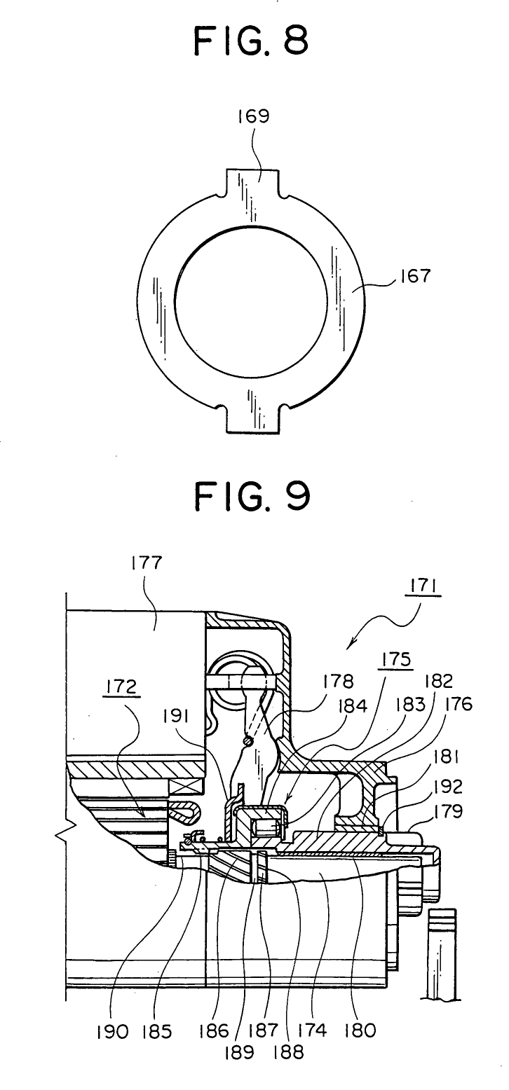

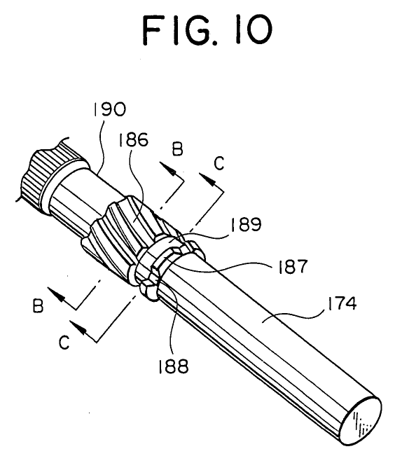

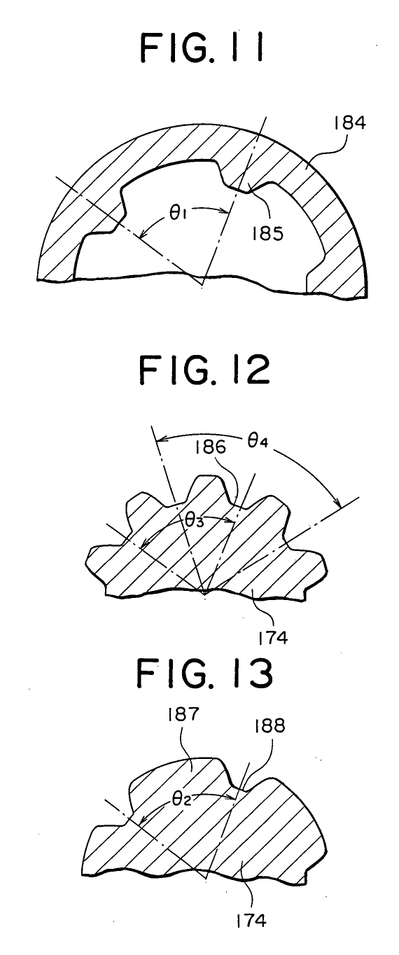

An assembling method for assembling the brake plate 19 to the concave portion 111 in the center bracket 18 is explained with reference to FIG. 1 and FIG. 5, which is an explanatory view of an assembly of a brake plate in accordance with the present invention. In FIG. 5, reference character V denotes a position in which five helical splines are provided, and W denotes a position in which ten helical splines are provided.
(1) The output shaft 115 is inserted from the rear side of the center bracket 18.
(2) The collar portion 43 of the clutch outer 4 is inserted into the substantially circular concave portion 111 in the center bracket 18, and advanced so that the end surface of the collar portion 43 abuts on a bottom surface X of the substantially circular concave portion 111. At this time, the helical spline connection in the clutch 110 is severed, and the clutch outer 4 is in a state of being capable of rotating freely in the circumferential direction.
(3) The clutch outer 4 is shifted in phase by one helical spline.
(4) The clutch outer 4 is returned to the front side, and moved to a position at which the pinion 3 projects to a maximum. The brake plate 19 is inserted from the radial direction of the output shaft 115, and set into the substantially circular concave portion 111 in the center bracket 18.
(5) The clip 113 is inserted into the clip groove 112 provided on the inner peripheral surface of the circular concave portion 111 in the center bracket 18 while the clip 113 is deflected using the attachment/detachment end portions 114 of the clip 113 with a tool such as pliers, by which the brake plate 19 is fixed.

As shown in FIG. 3, in a part of the brake plate 19, an opening 291 for allowing the shaft 115 to pass through is provided, and also an expanded portion 292 is provided in a part other than the opening 291.

Referring to FIGS. 2 and 5, a peripheral wall 280 around the concave portion 111 in the center bracket 18 is formed in a substantially annular shape having a cut portion 280-1 formed by cutting a part in the circumferential direction. On both sides of the cut portion 280-1, wall end portions 280-2 and 280-3, which are end portions of the continuous wall surface, are provided.

The depth in the axial direction of the cut portion 280-1 is approximately equal to the depth of the bottom surface of the concave portion 111.

A planar width l of the expanded portion 292 of the brake plate 19 is slightly narrower than a cut width L of the cut portion 280-1 of the peripheral wall 280 of the center bracket 18.

Therefore, when the brake plate 19 is placed in the concave portion 111, the expanded portion 292 is housed in the cut portion 280-1. Therefore, even when the collar portion 43 of the rotating clutch outer 4 comes into contact with the brake plate 19, the brake plate 19 is prevented from being rotated because the expanded portion 292 abuts on the wall end portion 280-2 or 280-3.

Because the brake plate 19 does not rotate, the inertial rotation of the clutch outer 4 (i.e., the motor 6) can be terminated rapidly.

Also, the clip groove 112 in the inner peripheral surface of the concave portion 111 in the center bracket 18 is exposed in wall end portions 280-2 and 280-3 by the cut portion 280-1. By causing the attachment/detachment end portions 114 to correspond to the position of the cut portion 280-1, the clip 113 can prevent the brake plate 19 from being rotated under the influence of rotational force of the collar portion 43 of the clutch outer 4, and the clip 113 can more surely be prevented from coming off from the clip groove 112.

The substantially circular brake plate 19 fitted in the substantially circular concave portion 111 has a thickness T1 larger than a distance T2 from a position at which the front end surface of the clutch 110, that is, the end surface of the collar portion 43 is caused to abut on the bottom surface X of the substantially circular concave portion 111 to a position at which the clutch 110 is helical spline connected.

The brake plate 19 has the following function in addition to its main object of reducing the number of relative rotations at the time of re-contacting, thereby reducing an impact force, and protecting strength members.

As shown in FIG. 5, T2 represents a range in which the clutch 110 can be rotated freely in its circumferential direction, and the relationship of T1>T2 holds. Therefore, the brake plate 19 having a thickness of T1 has a function of spacer for shifting the helical spline phase at the time of assembly.

Although one brake plate 19 having a thickness of T1 is provided in FIG. 5, a plurality of, for example, two or three brake plates may be provided. When the brake plate 19 is formed by a plurality of plates, the service life of the brake plate 19 can be prolonged by changing the sequence of a worn brake plate or by replacing only a worn brake plate.

1. A starter comprising an electromagnetic switch; a motor which has an armature pivotally supported on a rear bracket and a center bracket and is started by the energization of said armature caused by an ON operation of said electromagnetic switch; a pinion shift lever driven corresponding to the ON operation of said electromagnetic switch; a pinion which is engaged with a ring gear of an engine corresponding to the drive of said pinion shift lever while being rotated corresponding to the start of said motor; a clutch which is spline connected so that one of the motor output shaft side and the pinion shaft side has splines two times the number of splines ofthe other and a stopper mechanism utilizing the two-times splines with respect to the axial movement is provided; and a reducer provided between said motor output shaft side and said pinion shaft side, wherein
locking means for detachably fixing a brake plate is provided on a wall surface on the pinion side of the center bracket pivotally supporting an output shaft of said reducer.

2. The starter according to claim 1, wherein said locking means comprises a concave portion provided in said wall surface; a groove provided in an inner peripheral surface of said concave portion; and a clip fitted in said groove, and said brake plate is housed in said concave portion.

3. The starter according to claim 2, wherein a peripheral wall of said concave portion provided in said wall surface is cut partially in the circumferential direction, wall end portions being formed, and said clip has an opening portion and is formed, at its ends, with attachment/detachment end portions corresponding to said wall end portions.

4. The starter according to claim 1, wherein said brake plate consists of one or a plurality of plates, and has a thickness larger than a distance from a position at which said clutch is caused to abut on said wall surface to a position at which the splines of said clutch are engaged.

5. The starter according to claim 1, wherein said brake plate has a substantially circular shape having an opening in a part.

6. The starter according to claim 1, wherein said brake plate is formed of a resin material, and is impregnated with oil.

7. The starter according to claim 2, wherein a peripheral wall of said concave portion provided in said wall surface has a cut portion cut partially in the circumferential direction, and said brake plate is formed with an expanded portion corresponding to said cut portion.

8. The starter according to claim 2, wherein said brake plate consists of one or a plurality of plates, and has a thickness larger than a distance from a position at which said clutch is caused to abut on said wall surface to a position at which the splines of said clutch are engaged.

9. The starter according to claim 3, wherein said brake plate consists of one or a plurality of plates, and has a thickness larger than a distance from a position at which said clutch is caused to abut on said wall surface to a position at which the splines of said clutch are engaged.

10. The starter according to claim 2, wherein said brake plate has a substantially circular shape having an opening in a part.

11. The starter according to claim 3, wherein said brake plate has a substantially circular shape having an opening in a part.

12. The starter according to claim 4, wherein said brake plate has a substantially circular shape having an opening in a part.

13. The starter according to claim 2, wherein said brake plate is formed of a resin material, and is impregnated with oil.

14. The starter according to claim 3, wherein said brake plate is formed of a resin material, and is impregnated with oil.

15. The starter according to claim 4, wherein said brake plate is formed of a resin material, and is impregnated with oil.

16. The starter according to claim 5, wherein said brake plate is formed of a resin material, and is impregnated with oil.

17. The starter according to claim 3, wherein a peripheral wall of said concave portion provided in said wall surface has a cut portion cut partially in the circumferential direction, and said brake plate is formed with an expanded portion corresponding to said cut portion.

18. The starter according to claim 4, wherein a peripheral wall of said concave portion provided in said wall surface has a cut portion cut partially in the circumferential direction, and said brake plate is formed with an expanded portion corresponding to said cut portion.

19. The starter according to claim 5, wherein a peripheral wall of said concave portion provided in said wall surface has a cut portion cut partially in the circumferential direction, and said brake plate is formed with an expanded portion corresponding to said cut portion.

20. The starter according to claim 6, wherein a peripheral wall of said concave portion provided in said wall surface has a cut portion cut partially in the circumferential direction, and said brake plate is formed with an expanded portion corresponding to said cut portion.
